(19) United States
(12) Patent Application Publication
(10) Pub. No.: US 2012/0231924 A1
(43) Pub. Date: Sep. 13, 2012

(54) Optimized Continuous and Reversible Automatic Transmission

(76) Inventor: Alan Miranda Monteiro De Lima, Rio de Janeiro - RJ (BR)

(21) Appl. No.: 13/390,473

(22) PCT Filed: Jul. 23, 2010
(86) PCT No.: PCT/BR2010/000231

§ 371 Date: May 29, 2012

(30) Foreign Application Priority Data
Aug. 14, 2009 (BR) PI0905067-1

(51) Int. Cl. F16H 57/08; F16H 1/00

(52) U.S. Cl. 475/344; 74/412 R

(57) ABSTRACT

This invention is distinguished by a continuously variable transmission that can contain one or more gear sets. This gear set is composed of two coupled gears (attached to each other), concentric with different sizes, with one shaft free to rotate and orbit, because this rotation will furnish the velocity in the direction of the movement to alter gear ratios, without gear shifting; besides two additional concentric and finned structures that complete the system's functionality. There is no need to shift gears, optimizing the movement by means of planetary gears revolving around the drive and driven shafts.

### CROSS REFERENCE TO RELATED APPLICATIONS

This application claims the priority, under 35 U.S.C. §§119, 120, 363, and 371, of Brazilian patent application No. PI0905067-1 filed on Aug. 4, 2009, and International Application No. PCT/BR2010/000231 filed on Jul. 23, 2010, which designated the United States and was not published in English, the prior applications are herewith incorporated by reference in their entirety.

### STATEMENT REGARDING FEDERALLY SPONSORED RESEARCH OR DEVELOPMENT

Not Applicable

### FIELD OF THE INVENTION

The object of this invention belongs to a mechanical engineering field and deals with a model of a continuously variable transmission, made up of a gearbox located between the drive shaft and the driven shaft of self-propelled vehicles.

### BACKGROUND OF THE INVENTION

The object of this invention is a model for a revolutionary continually variable transmission, however, before describing the invention we will review the most common types of transmissions used in self-propelled vehicles.

Basically, there are three types of transmissions/gearboxes on the market:

1—Manual Shift: This transmission is well known because the gear changes are made manually. One has 4 or 5 forward gears and one reverse. The advantages are: a more affordable price, sportier driving, well accepted by the market. Defects: it has a clutch pedal, the gear change is manual, making driving more tiring, and it has a considerable size and weight.

2—Automatic Shift: This type of transmission does not have a clutch, replaced by a torque converter that plays a role similar to the clutch in manual transmissions. The fundamental difference between a manual gearbox and an automatic gearbox is that the manual gearbox engages and disengages different sets of gears of the drive train in order to achieve different drive ratios while, in an automatic transmission, the same set of gears produces different drive ratios. The planetary gearing is the device that makes this possible in the automatic gearbox.

When one looks inside the automatic gearbox, one sees a great variety of components in a relatively small space. Some of them are:
An ingenious set of planetary gears.
A set of belts that link some parts of the gearbox set.
A set of belts that link some parts of the gearbox.
A set of three clutches immersed in oil that links other parts of the gearbox.
A hydraulic system that controls the gears and the belts.
A gear pump that makes the hydraulic fluid of the gearbox circulate.

The main point of this transmission is the set of planetary gears, the only part capable of creating all of the transmission ratios that the gearshift can produce. All the other components of the transmission are there to help it do its work. An automatic transmission contains two complete sets of planetary gears making up a single component.

Thus, this set of gears is capable of producing all the gear ratios, avoiding successive couplings.

The advantages of this type of transmission: One has a more comfortable driving experience, because one does not have to switch gears nor does one have to press the clutch.

Disadvantages: Transmission with a lot of parts and relatively expensive. It has a limited number of gear ratios, problems for overdriving in order to overtake and/or with downshifting, one feels a slight hesitation in the change of gears.

3—CVT Gearbox (Continuously Variable Transmission): Differently from the traditional automatic transmission, those of the continuously variable type do not have a gearbox with a given number of gears. The most common CVT type works with an ingenious system of pulleys that allows for an infinite variety between the highest and lowest gears, without discrete steps or gear changes.

When one looks at an automatic planetary gearbox, one sees a complex array of devices, such as gears, belts, clutches and governors. On the other hand, the continuously variable transmission is simpler. Most CVTs have just three basic components:
A metallic or rubber belt;
A variable entrance “drive” pulley;
An exit “driven” pulley that is also variable.

The CVTs also have several microprocessors and sensors, but the three components described above are the key elements that are necessary for its functioning.

The pulleys with variable diameters are the heart of the CVT. Each pulley is made up of two cones, one in front of the other and capable of shifting back and forth. A belt passes through the groove between the two cones. When the two cones of the pulley are separated from each other (small diameter), the belt passes through the part of the groove that is lower, so that the radius of the belt around the pulley is less. When the cones are together (large diameter), the belt passes through the groove that is higher and the radius is greater. The CVTs are able to use hydraulic pressure, centrifugal force or tension by means of springs in order to create the force required to adjust the halves of the pulleys. When the pulleys are apart, the belt goes to the lower one and the radius is less. When the pulleys are together, the belt passes to the higher one and the radius increases. The ratio of the changes in radii between the drive and driven pulleys is what determines the gear ratio.

CVTs have been used for years in machine tools and drill presses. They are also used in a variety of vehicles, including tractors, snowmobiles and scooters. In all these cases, the gearboxes are in contact with high density rubber belts, those that are able to slide and expand, thus reducing their efficiency.

There are other types of CVT transmissions, but they all have the same principle. Advantages: Constant acceleration, without steps, since from neutral to cruising speed, the “gear shift shocks” are eliminated, allowing for a smoother ride. It maintains the vehicle within its best power range, regardless of the velocity, resulting in lower fuel consumption and better response to changes in conditions related to increasing acceleration in order to obtain greater speed.

One of the disadvantages of this system is the delay in response between the increase in engine revolutions and its increase in speed.

The CVTs are efficient driving uphill. The search for gears does not happen because the CVT shifts directly and without steps to the most appropriate gear for the given condition. An automatic transmission box reduces and increases the gears several times until it encounters the best gear, which is less efficient.

Traditionally, the CVTs with belts are limited in the amount of torque that they are able to withstand, besides being larger, heavier and more expensive than their corresponding automatic and manual transmissions.

The present disclosure solves problems that exist in current gearing systems.

### SUMMARY OF THE INVENTION

The object of this invention is a reversible optimized continuous automatic transmission, made up of a system of gears located between the driven shaft and the drive shaft of automobiles, which allows for the change in gears automatically due to the optimized power/speed ratio, permitting a ride that is safer, more economic, comfortable with more rapid responses, besides this, the optimized and reversible continuous automatic transmission of this invention has a very low production cost.

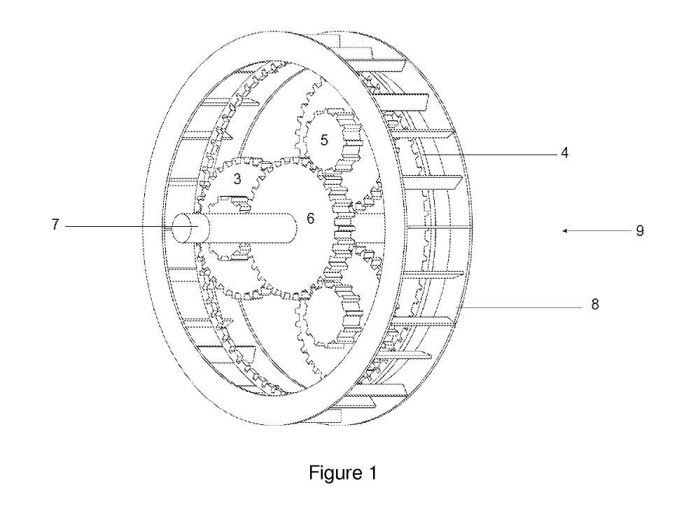

FIG. 1 is a front perspective view of a transmission according to the invention from a driven shaft side where the driven shaft and the gear system are exposed; and

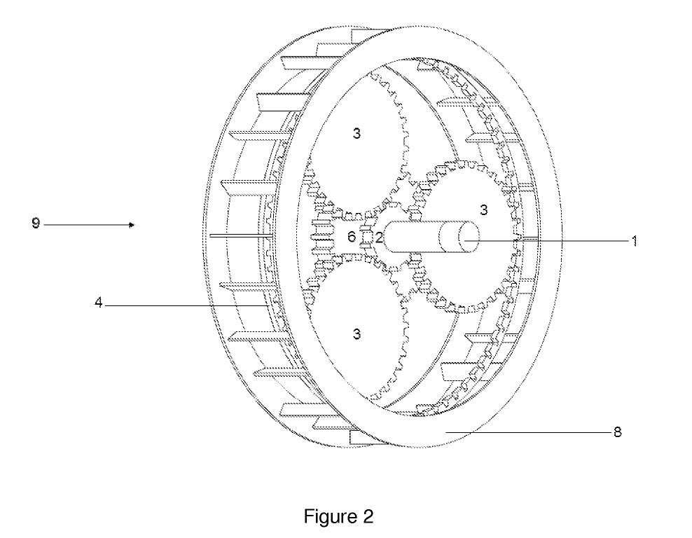

FIG. 2 is a rear perspective view of the transmission of FIG. 1 from a drive shaft side where the drive shaft and the gear system are shown.

### DETAILED DESCRIPTION OF THE INVENTION

The optimized and reversible continuous automatic transmission of this invention comprises a gear system (9) located between the gears (2) of the drive shaft (1) and the gears (6) of the driven shaft (7) that transmits power to the wheels. The gear system of this invention is made up of two gears (3) and (5), which are concentric, coupled, and have different sizes, functioning as planetary gears with a free shaft between the two gears of the drive shaft (1) and the driven shaft (7). These gears are contained within a larger annulus (4) with teeth on the inside and fins on the outside, which is, by itself, within a bigger circular structure (8), with fins on the inside moving in solidarity with the driven axis (7), however it does not have direct contact with the annulus (4). The interaction between the annulus (4) and the circular structure (8) occurs by the use of hydraulic fluid; optionally, the interaction between the annulus (4) and the circular structure (8) could take place by magnetism. This gearing system allows the force to be transmitted according to requirements and makes possible a continuously variable transmission that simulates infinite gear changes between the first gear, which is defined by the difference in sizes between the gears, and the last gear where the driven shaft (7) has the same rotation as the drive shaft (1), yielding a 1:1 ratio between the said driven shaft (7) and the drive shaft (1).

The set of gears (3) and (5) of this invention could have been just one set of gears, preferably two or more gears sets (3) and (5), but better yet would be three gear sets (3) and (5) in order to give more balance to the system. If there are two gear sets they should be diametrically opposite each other, if there are three they should be located at fixed angles of 120 degrees, so they are attached to revolve as one. Preferably, three gears are used in this invention located at fixed angles of 120 degrees.

No shifting of gears is necessary. The main difference between the invention and the other types of existing automatic transmissions is that, in the invention described here, the drive shaft (1) and the driven shaft (7) have a more intimate relationship because the driven shaft itself (7) is rotated by the drive shaft (1) and the driven shaft (7) by the circular structure (8), which drives the annulus (4) in other words, the driven shaft (7) is also the drive shaft.

With this system, an optimized and reversible continuously variable transmission is possible by a much simpler and less costly manner, without the need for belts, sensors and other electronic equipment.

The main advantages in relation to the current methods are:
A safe, comfortable drive with quick responses, without the need for changing gears because, presently, either one has a comfortable drive or a drive with quick and safe response, but not both and, with this new system, one can have the two at the same time;
Smaller size and lower cost;
Greater durability due to the total absence of fragile parts;
There is no need for shifting gears, and;
This object also has very few components, which simplifies the manufacturing process.

FIG. 1 shows the scheme of the automatic transmission of this system that displays the preferred three planetary toothed gears (3) working together to form a structure placed at equidistant angles and with a freely rotating shaft. The planetary gears (3) are made up of two coupled and concentric gears (3) and (5), one with a smaller diameter (5) and the other with a larger diameter (3). These ratios of configuration sizes may vary according to the design with the characteristics in which it will be installed, such as, for example, power, desired gear ratio, weight, final velocity, maximum revolution of the engine, etc.

The planetary gears (3) have free shafts and these, besides rotating on their own shafts, revolve around the drive shaft (1) and the driven shaft (7) by the rotation given by the toothed gears (6) of the drive shaft (1); the planetary gears (3), besides having a freely rotating shaft, have another degree of liberty, that of rotating around the drive shaft (1) and the driven shaft (7) so that the planetary gears (3) are the only shaft that make up the center of its circular movement. Thus, the planetary gears (3), besides having a rotation of their own shaft, imposed by the drive shaft (1), revolve around the drive shaft (1) and the driven shaft (7).

Besides this, the annulus (4) has internal teeth to make the gears revolve. The annulus (4) is locked in order to rotate only in the direction of the drive shaft (1). The annulus (4) has internal teeth and fins on the outside. The circular structure (8) is smooth on the outside and has fins on the inside. The structure (8) remains fixed (it will have a similar proportional movement, which is the main characteristic of the system) to the driven shaft (7), this will make the gear ratios proportional to the drive shaft (1) and the driven shaft (7). These fins should function as a torque converter something similar, in order to drive the annulus (4) by drag force (this force could also be developed by magnetic measures). Between the annulus (4) and the circular structure (8) there is a fluid that will be moved by the fins of the circular structure (8) and that fluid will move the annulus (4). The pressure and viscosity of this fluid, as well as the distance between the annulus (4) and the circular structure (8) and the inclination and/or type of fins should be such that the drag force that the circular structure (8) exerts on the annulus (4) is optimized, this will depend on the parameters of the vehicle, such as weight, power, etc. This drag force could be such that the system is always trying to reach a gear ratio of 1:1; however the gear ratio in which the vehicle finds itself will depend on the instantaneous dynamic conditions such as acceleration and inertia. The fluid pressure could be steady and constant or variable by an oil pump. As with the circular structure (8), it will have the same rotation as the driven shaft (7) if the driven shaft (7) is rotating slowly, the circular structure (8) will transfer low rotation to the annulus (4); otherwise, it will transmit high rotation by the hydraulic drag force.

When the vehicle starts to move, the annulus (4) will be stopped, as if in first gear; with the beginning of movement, the annulus (4) will begin to rotate due to the drag force generated by the rotation of the structure (8) that is connected to the driven shaft (7) beginning to shift up with the rotation of the annulus (4), (1), in other words, up to the ratio of 1:1. The system will always seek the 1:1 ratio, in other words, until the driven shaft (7) is equal to the rotation of the drive shaft (1), but what defines the true ratio is the instantaneous inertia of the vehicle, the rotation of the driven shaft (7) and the rotation of the drive shaft (1). This difference in rotation of the annulus (4) is what supplies the other velocity component so that shifts are made without any changes in gears. (V₁) is the velocity of rotation transferred by the drive shaft (1) to the planetary gears (3) and (V₂) is the rotation transferred by the planetary gears to the driven shaft (7). (V₂) will have three velocity components:
V₂₍₁₎ imposed by the drive shaft (1) by the gear system (9) and proportional to the drive shaft (1);
V₂₍₂₎ exists due to the rotation of the planetary gears and proportional to the drive shaft (1); and
V₂₍₃₎ component due to the rotation of the annulus (4) exerted by the circular structure (8) and proportional to the drive shaft (1) and to the driven shaft (7).

The optimized and reversible continuous automatic transmission is characterized by the free rotation of the planetary gears, which are coupled and concentric, with different sizes, around the drive shaft (1) and the driven shaft (7), and with these planetary gears making the connection between the movements of the two drive (1) and driven (7) shafts, and with another two gears/external support structures to complement the functionality of the system. The variation of the gear shifts results from the rotation and transmission of the planetary gears in direction of the movement due to the circular structure (8) being connected to the drive shaft (7) and at the same time is driving the annulus (4) by drag force. In other words, the drive shaft (1) makes the driven shaft (7) move, which rotates the circular structure (8) which rotates the annulus (4), which makes the velocity V₂₍₃₎ increase and rotate the drive shaft (7), so that the gear ratio is proportional to the drive shaft (1) and the driven shaft (7).

The rotation of the annulus (4) could be imposed by other measures such as, for example, the addition of an electric motor with a variable rotation speed in accordance to the rotation of the driven shaft (7) in order to move it; however, using fluid makes it simpler.

The placement of the gears could be done in other ways, however they should be arranged in such a way that will supply the variations of the rotation of the driven shaft (7) that will be the sum of the velocity components of rotation on the transmission point for the driven shaft (7) that are the contact points between the gears of the drive shaft (1) and the planetary gears (3). (V₁) and the contact points of the planetary gears (3) with the gears of the driven shaft (7) (V₂).

When the angular velocity of the annulus (4) is equal to that of the circular structure (8), the rotation of the driven shaft (7) will be equal to the rotation of the drive shaft (1), and the system will rotate as one; in other words, the gears of the drive shaft (1), the planetary gears and the gears of the driven shaft (7), and the two external auxiliary structures/gears will rotate as if they were welded to each other, making a single body. In this situation, the gear ratio is 1:1. Since the number of angular velocities of the annulus (4) is infinite, this system simulates an infinite number of gears, between minimum and maximum gear ratios. The minimum is specified by the difference in sizes between the gears of the drive shaft (1), the planetary gears (3) and the gears of the driven shaft (7); and the maximum is 1:1.

One of the problems found with automatic transmission is the gear reduction for a safe overtaking. One solution used for current automatic transmission is the use of the kick-down device, which allows for downshifting that permits overtaking with agility. However, this reduction is delayed and one feels a lurch, depending on the speed and the vehicle's present gear. With this invention, this reduction is instantaneous and optimized, without any lurching. Therefore, when one accelerates to overtake, the gear system (9) increases its rotation and thereby increases the rotation of the planetary gears (3), which, due to the difference of size between them, results in the slowing of the annulus (4) in the direction of the motion, because upon accelerating the vehicle, one increases the binary of forces in the rotation of the gears (3) between the gear system (9) and the annulus (4), which allows the inertia of the annulus (4) to increase, increasing its resistance to the drag force and reducing its rotational velocity and, therefore, instantaneously reducing the current gear and setting the most appropriate gear for overtaking.

For the appropriate purposes, it should be noted that this invention is not limited to the modes described, and it is possible to introduce any modifications that may be appropriate, with the conditions that the essential characteristics of this invention, as described in the claims, are not changed.

1-5. (canceled)

6. An automatic transmission, comprising:
an optimized and reversible continuous automatic transmission, comprising,
a drive shaft;
a driven shaft operable to transmit power to at least one wheel;
gears associated with the driven shaft; and
a gear system located between the drive shaft and the gears of the driven shaft, the gear system transmitting power to the at least one wheel.

7. The automatic transmission according to claim 6, comprising:
a first gear;
a second gear;
wherein the first gear and the second gear are coupled, concentric, and of different sizes; and
wherein the first gear and the second gear are planetary gears with a free shaft between the two gears located between the drive shaft and the driven shaft.

8. The automatic transmission according to claim 7, wherein the first gear and the second gear are positioned at fixed angles of 120 degrees.

9. The automatic transmission according to claim 6, further comprising:
an annulus with internal teeth and outside fins;
a circular structure enclosing the annulus without direct contact with the annulus, the circular structure having:
internal fins; and
movement equal to the driven shaft.

10. The automatic transmission according to claim 9, where an interaction between the annulus and the circular structure takes place through utilization of one of hydraulic fluids and magnetism.
